(19) United States
(12) Patent Application Publication
(10) Pub. No.: US 2016/0147427 A1
(43) Pub. Date: May 26, 2016

(54) THIN CLIENT COMPUTING DEVICE TASKBAR AND WIDGETS

(71) Applicant: HEWLETT-PACKARD DEVELOPMENT COMPANY, L.P., Houston, TX (US)

(72) Inventors: Fletcher Liverance, Kent, OH (US); Matthieu Clemenceau, Houston, TX (US); Daryl T Poe, Fort Collins, CO (US)

(21) Appl. No.: 14/898,256

(22) PCT Filed: Jun. 26, 2013
(86) PCT No.: PCT/US2013/047949

§ 371 Date: Dec. 14, 2015

(51) Int. Cl. G06F 3/0484; H04L 29/06; H04L 29/08; H04L 12/24; G06F 3/0481; G06F 3/0482

(52) U.S. Cl. CPC G06F 3/04847; G06F 3/04817; G06F 3/04842; G06F 3/0482; G06F 3/04845; H04L 67/14; H04L 41/0803; H04L 41/22; H04L 67/42

(57) ABSTRACT

In one example in accordance with the present disclosure, a method is provided. The method includes accessing, via a thin client computing device, an administrator-mode interface, where the administrator-mode interface is accessible by selection of an icon within a taskbar, and where the administrator-mode interface is the only interface to access the thin client computing device settings. The method additionally includes selecting, via the administrator-mode interface, a plurality of widgets to be displayed within the single taskbar during a user-mode interface, and configuring the type of content provided by at least one of the plurality of widgets

### BACKGROUND

In a thin client computing environment, users do their computing on a virtual desktop residing on a remote server. The users access the environment through a thin client computing device, which is a simple computing device that frequently comprises no hard drives or other moving parts and relies on the server for most if not all computing resources. This thin client architecture is beneficial for organizations dealing with e.g., issues related to desktop replacement costs, issues related to network security, issues related to data access for mobile/remote users, issues related to supporting applications on diverse hardware, and/or issues related to ensuring data is accessible and secure.

### BRIEF DESCRIPTION OF THE DRAWINGS

Examples are described in the following detailed description and in reference to the drawings, in which:

FIG. 1 depicts an example thin client computing device in accordance with an implementation;

FIG. 2 depicts an example of the user-mode interface in accordance with an implementation;

FIG. 3 depicts an example of the user mode interface presenting active content in accordance with an implementation;

FIG. 4 depicts an example of the user-mode interface with an icon to select to enter the administrator-mode interface in accordance with an implementation;

FIG. 5 depicts another example of the user-mode interface in accordance with an implementation;

FIG. 6 depicts a process flow diagram of an example process that may be conducted by the thin client computing device and/or taskbar module of FIG. 1 in accordance with an implementation; and

FIG. 7 depicts an example thin client computing device comprising a machine-readable medium in accordance with an implementation.

### DETAILED DESCRIPTION

As mentioned above, thin client computing devices are useful for various reasons. The most common users are participants in the healthcare, government, industrial, retail, financial, and educational industries. While these participants are in agreement on their desire for the thin client architecture, each generally has its own unique requirements in terms of interface configuration and/or user accessibility. For example, some organizations want to give users various privileges, while other organizations want to completely lock down the system, with differing definitions of “lock down” from one organization to next. Moreover, these organizations commonly disagree on how the interface should be configured and/or what type of content should be displayed. Still further, even for the content that is displayed, the content is generally static and/or requires launching another application to view more detailed content, which tends to be a distraction from the remote session experience.

Aspects of the present disclosure address at least the above-mentioned issues by providing a novel and previously unforeseen tool that enables each organization to customize the thin client interface in a manner that best suits their particular needs, as well as provide content that is helpful to the user and that does not interfere with the remote session experience. More precisely, aspects of the present disclosure provide a unique taskbar that enables access to administrator-mode interface and that displays active content therein. This administrator-mode interface is configured to be the only interface to the thin client computing device settings, and, among other things, facilitates configuration of user access privileges, selection of a plurality of widgets to be displayed in the taskbar during the user-mode interface, and configuration of the type of content to be displayed within the selected widgets. For example, widgets may be selected and/or configured to provide active content from applications running on the thin client computing device (e.g., an application connecting to a remote desktop or remote application such as a Citrix® application, a Microsoft® remote desktop application, and a VMware® application). Moreover, widgets may be selected and/or configured to provide first content when connected in a remote session and to provide second content with not connected in the remote session. These features as well as various other features are discussed in greater detail below with reference to various example implementations and figures.

In one example implementation in accordance with the present disclosure, a thin client computing device is provided. The thin client computing device comprises a communication interface and a taskbar module. The communication interface is to communicate with a remote server to establish a remote session. The taskbar module is to provide an administrator-mode interface, wherein the administrator-mode interface is (i) accessible by selection of an icon within a taskbar, (ii) the only interface to the thin client computing device settings, (iii) enables selection of widgets to be displayed in the taskbar during a user-mode interface and configuration of the type of content to be displayed within at least one of the selected widgets, and (iv) enables configuration of user access privileges with respect to at least one of configuring connection settings, configuring display settings, configuring audio settings, powering off the thin client computing device, and rebooting the thin client computing device. Furthermore, the taskbar module is to provide the user-mode interface, wherein the user-mode interface comprises the taskbar as configured via the administrator-mode interface, and wherein user access is limited in the user-mode interface based on the user access privileges as configured via the administrator-mode interface.

In another example implementation in accordance with the present disclosure, a method is provided. The method comprises accessing, via a thin client computing device, an administrator-mode interface, wherein the administrator-mode interface is accessible by selection of an icon within a single taskbar, and wherein the administrator-mode interface is the only interface to access the thin client computing device settings. The method additionally comprises selecting, via the administrator-mode interface, a plurality of widgets to be displayed within the single taskbar during a user-mode interface, wherein at least one of the plurality of widgets is to communicate with an application running on the thin client computing device and provide active content from the application within the single taskbar. The method further comprises configuring, via the administrator-mode interface, the type of content provided by at least one of the plurality of widgets, wherein the type of content provided by the at least one of the plurality of widgets differs when connected in a remote session and when not connected in the remote session.

In yet another example implementation in accordance with the present disclosure, a non-transitory machine readable medium is provided. The machine readable medium comprises instructions which, when executed, cause a thin client computing device to provide an administrator-mode interface, wherein the administrator-mode interface is (i) accessible by selection of an icon within a taskbar, (ii) the only interface to the thin client computing device settings, (iii) enables selection of widgets to be displayed in the taskbar during a user-mode interface, (iv) enables configuration of the type of content to be displayed within at least one of the selected widgets, and (v) enables configuration of user access privileges. The instructions further cause the thin client computing device to provide the user-mode interface, wherein the user-mode interface comprises the taskbar as configured via the administrator-mode interface, and wherein user access is limited in the user-mode interface based on the user access privileges as configured via the administrator-mode interface. The user access privileges comprise at least one of connection settings privileges, display settings privileges, audio settings privileges, powering off the thin client computing device privileges, and rebooting the thin client computing device privileges, and at least one of the selected widgets is to communicate with an application running on the thin client computing device and provide active content from the application within the taskbar.

As used herein, the term “widgets” should be generally understood as meaning software applications or plugins that can be installed within the taskbar and executed to provide received/fetched information and/or to provide access to other applications. The widgets may be configurable and include sub-widgets. Further, the widgets may be seen as an icon and/or text within the taskbar.

As used herein, the term “administrator-mode interface” should be generally understood as meaning the graphical user interface (GUI) presented when the user has been properly authenticated and entered administrator mode. This interface may be presented as part of the taskbar (e.g., in the form of a pop-out from the taskbar). Furthermore, common portions of the user-mode interface may be displayed while the administrator-mode interface is presented.

As used herein, the term “user-mode interface” should be generally understood as meaning the GUI presented when the user operating the thin client computing device under normal operating conditions and when not accessing the administrator-mode interface. In addition, the interface may be presented as part or all of a taskbar.

As used herein, the term “thin client computing device” should be generally understood as meaning a computing device that relies on a server to perform data processing. For example, the thin client computing device may send keyboard and mouse inputs to the server and receive screen output in return. Furthermore, the thin client will frequently comprise no hard drive or other moving parts.

As used herein, the term “remote session” should be generally understood as meaning a network connection with a remote server that is configured to provide a remote desktop or application to the thin client computing device. Moreover, the remote session may be used to access programs, files, and network resources on the server.

As used herein, the term “user” should be generally understood as meaning an individual that interacts with the thin client computing device. The interaction may be from a location local to the thin client computing device and/or from a location remote with respect to the thin client computing device. In some examples, the user may be an administrator that manages aspects of the thin client computing device.

As used herein, the term “active content” should be generally understood as meaning dynamic or real-time content received from an application. The content is not static and changes constantly or periodically based on information received from the application.

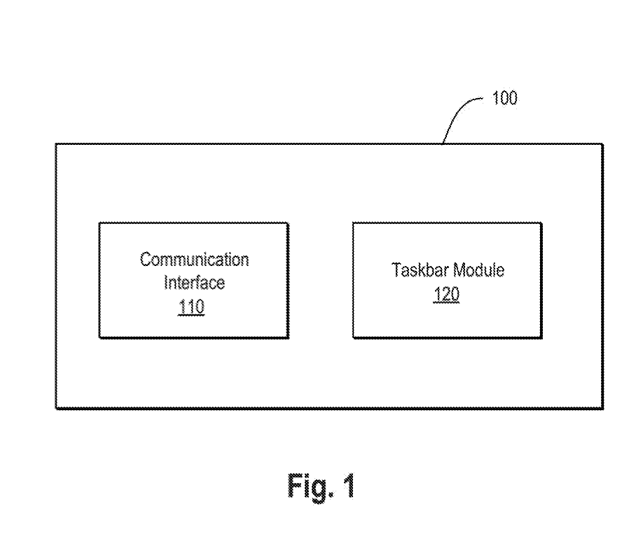

FIG. 1 depicts an example thin client computing device 100 in accordance with an implementation. The thin client computing device 100 comprises a communication interface 110 and a taskbar module 120. It should be readily apparent that the thin client computing device 100 is a generalized illustration and that other elements may be added or existing elements may be removed, modified, or rearranged without departing from the scope of the present disclosure. For example, other components such as fans, codecs, buffers, input/output (I/O) components, timers, clocks, switches, light emitting devices, and/or other common thin client computing device components may be included in the thin client computing device 100, and are not shown for the sake of clarity and brevity.

The communication interface 110 may comprise a wireless network interface (e.g., to communicate in accordance with IEEE 802.11a/b/g) and/or a wired network interface (e.g., to communicate in accordance with IEEE 802.3). Moreover, the communication interface 110 may comprise transmitters, receivers, transceivers, antennas, ports, PHYs, and/or other communication components. In accordance with various implementations, the communication interface 110 may be utilized by the thin client computing device 100 to establish a remote session with at least one server. Once the remote session is established, the thin client computing device 100 may communicate with the server to access programs, files, and network resources on the server. For example, the thin client computing device 100 may receive a remote or virtual desktop from the server for presentation on a display associated with the thin client computing device 100.

The communication interface 110 may be communicatively coupled to the taskbar module 120. Depending on the implementation, the taskbar module 120 may be implemented in hardware, software, or a combination of both. For example, the taskbar module 120 may comprise machine-readable instructions executable by a processing device to cause the thin client computing device 100 to conduct functions discussed herein. Alternatively or in addition, the taskbar module 120 may comprise a hardware equivalent such as an application specific integrated circuit (ASIC), a logic device (e.g., PLD, CPLD, FPGA, PLA, PAL, GAL, etc.), or combination thereof configured to conduct functions discussed herein. In particular, the taskbar module 120 may provide an administrator-mode interface and a user-mode interface. That is, the taskbar module may cause the administrator-mode interface or the user-mode interface to be presented on a display associated with the thin client computing device 100.

With specific respect to the administrator-mode interface, this interface may be accessible by selection of an icon located within a taskbar. For example, a wrench icon may be displayed within the taskbar during the user-mode interface, and selection of the wrench icon may provide access to the administrator mode interface. In some implementations, access may only be granted after the user is properly authenticated. Depending on the implementation, this may comprise authentication based on biometrics, a smartcard, and/or credentials (e.g., a password). Once access is granted, the administrator-mode interface enables configuration of privileges, settings, and/or the taskbar. In some implementations, the administrator-mode interface is the only interface to adjust/configure settings/privileges associated with the thin client computing device 100.

With specific respect to configuring the taskbar, the administrator-mode interface may enable selection of widgets to be displayed in the taskbar at least during the user mode interface. For example, at least the following types of “control panel” widgets may be selected for inclusion within the taskbar: a certificate management widget, a dynamic host configuration protocol (DHCP) widget, a keyboard shortcut widget, a system resource monitor widget, a text editor widget, a terminal widget, an active directory join tool widget, an update management tool widget, a factory reset widget, a device shadowing configuration widget, a background and screensaver configuration widget, a date/time widget, a language widget, a network settings widget, a security and account settings widget, a display preference widget, a keyboard layout widget, a mouse feedback widget, a touchscreen configuration widget, a printer configuration widget, an audio configuration widget, and a USB device management widget.

In addition, at least the following types of “connection” widgets may be selected for inclusion within the taskbar: a Citrix® XenApp and XenDesktop login widget, a Citrix® XenApp application launch shortcuts widget, a Microsoft® RDP login widget, a VMware® View login widget, a Firefox® browser launcher widget, a Teemtalk terminal emulation widget, a UC management application widget (e.g., VOIP Softphone), a single sign on widget, a smartcard and/or badge login solutions widget, a multiple connection instance configuration widget, and a general and connection specific settings information for each connection type widget.

Furthermore, at least the following types of “other configuration” widgets may be selected for inclusion within the taskbar: a system shutdown/reboot/logoff widget, a local time widget, a currently running tasks widget, various system taskbar widgets (e.g., audio, network, keyboard, CPU, and/or monitor widgets), and various system information widgets (e.g., network information, firmware information, system logs, and/or network tools widgets).

In addition to selecting of widgets to be displayed in the taskbar, the administrator-mode interface may further enable configuration of the type of content to be displayed within the selected widgets. For example, for the local time widget, the user may configure the type of display (e.g., analog or digital), the type of font, and/or the size of font. Similarly, the administrator-mode interface may further enable configuration of a widget to provide first content while connected in a remote session, and provide second content when not connected in the remote session. For example, looking at the Citrix® XenApp connection widget, the administrator-mode interface may be utilized to have the widget show what server the connection is to, which applications are currently running, what options are enabled (e.g., multimedia redirection, flash redirection, currently connected USB devices, current language, etc.) while connected in the remote session. By contrast, the administrator-mode interface may be utilized to have the Citrix® XenApp widget show statistics on the last time a user was connected, their user name, and what servers are currently available to connect to while not connected in a remote session.

Still further, the administrator-mode interface may further enable configuration of user access privileges. In particular, the administrator-mode interface may allow the administrator to configure whether or not a user has the privilege to configure connection settings, configure display settings, configure audio settings, power off the thin client, and/or reboot the thin client.

Turning now to the user-mode interface, the taskbar module 120 may provide this interface when the user is operating the thin client computing device under normal operating conditions and when not accessing the administrator-mode interface. This interface may be presented as part or all of a taskbar. In one example, this interface comprises the taskbar as configured via the administrator-mode interface, and user access is limited in the user-mode interface based on the user access privileges as configured via the administrator-mode interface. Moreover, this interface may provide an icon (e.g., a wrench icon) to enable a user to enter the administrator-mode interface.

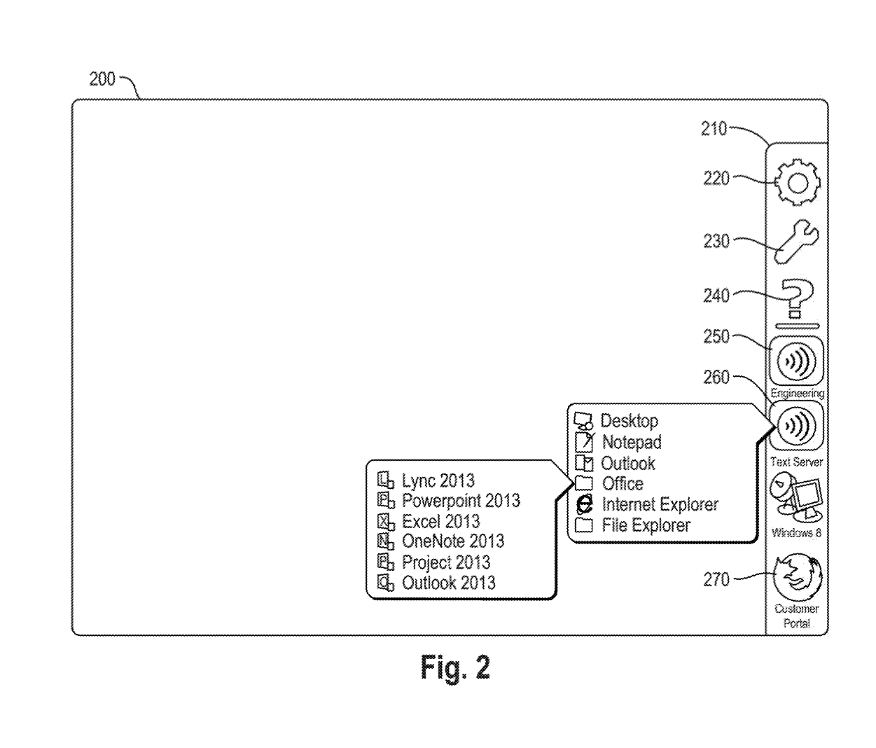

FIG. 2 depicts an example of the user-mode interface 200 in accordance with an implementation. More particularly, FIG. 2 depicts the interface with the taskbar 210 shown to a user while in the user mode. As can be seen, the taskbar 210 includes a plurality of widgets 220-270. In this example, the gear icon 220 is a connection management widget, the wrench icon 230 is a control panel widget that enables access to admin mode, and the question mark icon 240 is a system information widget that enables a user to determine information such as the IP address, firmware type, etc. Additionally, two Citrix® receiver widgets are shown (250 and 260), with the lower Citrix® receiver widget 260 showing available applications on the server when selected. Furthermore, a Firefox® browser launcher widget 270 is shown that launches a Firefox® browser window when selected.

As mentioned above, the widgets shown within the taskbar while in the user-mode interface are selected, configured, and/or positioned while in the administrator-mode interface. That is, the administrator-mode interface can be used to select which widgets are included in the taskbar during the user-mode interface and what content is presented by each selected widget. For example, the administrator may remove the second Citrix® receiver widget 260, the gear icon 220, and question mark icon 240 from the displayed taskbar while in the user-mode interface.

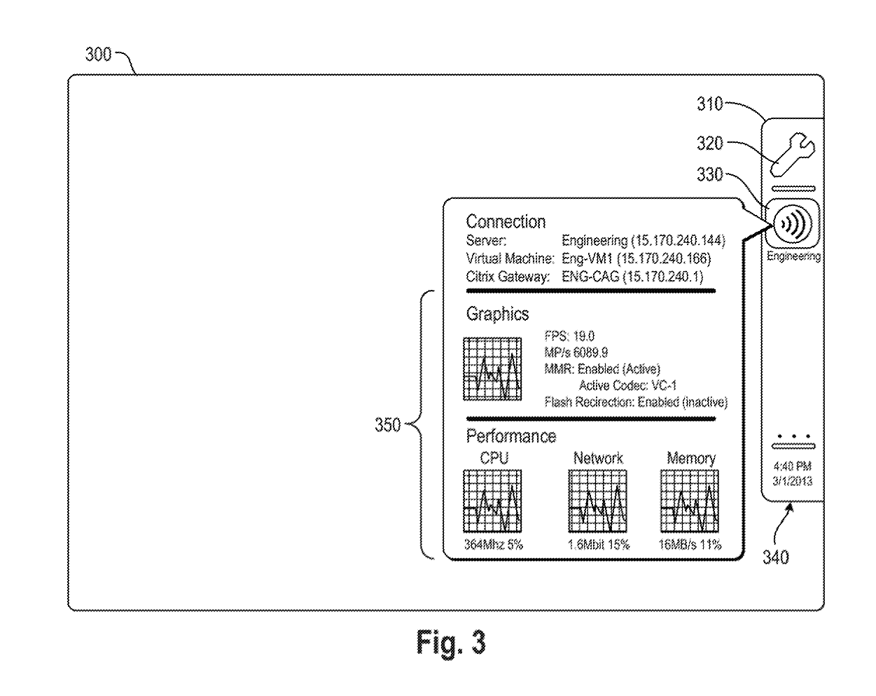

FIG. 3 depicts an example of the user mode interface 300 presenting active content in accordance with an implementation. More particularly, the taskbar 310 in FIG. 3 has been configured by the administrator to only include the wrench icon 320 (i.e., to enter administrator mode), a Citrix® receiver widget 330, and a date/time widget 340. With particular respect to the Citrix® receiver widget 330, the administrator has configured the widget to provide information about the connection (i.e., server, virtual machine, and Citrix® gateway identification information) as well as active content 350 in the form of real-time graphics information and real-time performance information. The Citrix® receiver widget 330 obtains this information by communicating with at least one running application (e.g., the Task Manager application) to obtain run-time configuration and performance details. More specifically, the Citrix® receiver widget 330 obtains this information by communicating with at least one running application or system service via an Application Programming Interface (API). This and other widgets may communicate with any number of services running on the thin client computing device, or may communicate via the network and retrieve information via APIs from remote services and display the information via the widget. The retrieved content 350 is embedded and displayed in the taskbar 310 rather than via tiles in a full screen application, thereby ensuring that the user has a seamless uninterrupted remote application experience. As mentioned, the administrator may manipulate the visible content in any of the widgets via the administrator-mode interface.

It should be noted that while FIGS. 2 and 3 are described above as being particular to user mode, various aspects of the taskbar (210 and 310) may appear the same in administrator mode. That is, when the user is in admin mode, the taskbar (210 and 310) may appear similar or the same as shown in FIGS. 2 and 3.

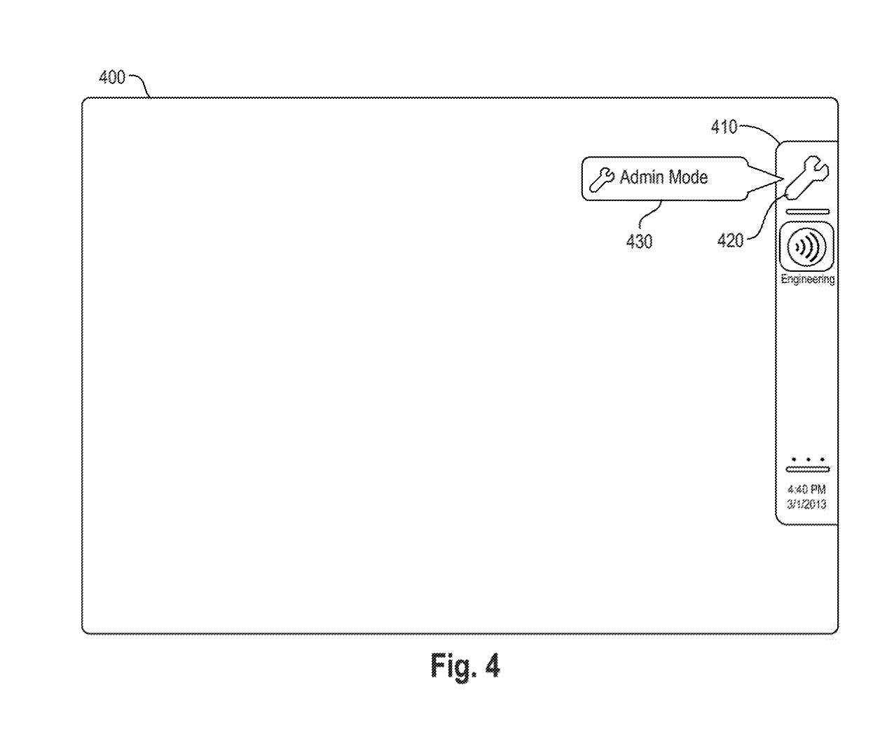

FIG. 4 depicts an example of the user-mode interface 400 with an icon 420 selected to enter admin mode in accordance with an implementation. In particular, the taskbar 410 in FIG. 4 is similar to the taskbar 310 in FIG. 3, but FIG. 4 shows that the wrench icon 410 is selected, and the user is presented the option 430 to enter administrator mode and view the administrator-mode interface. As mentioned above, access to the administrator mode may require the user to be authenticated before the user is granted access to the administrator-mode interface.

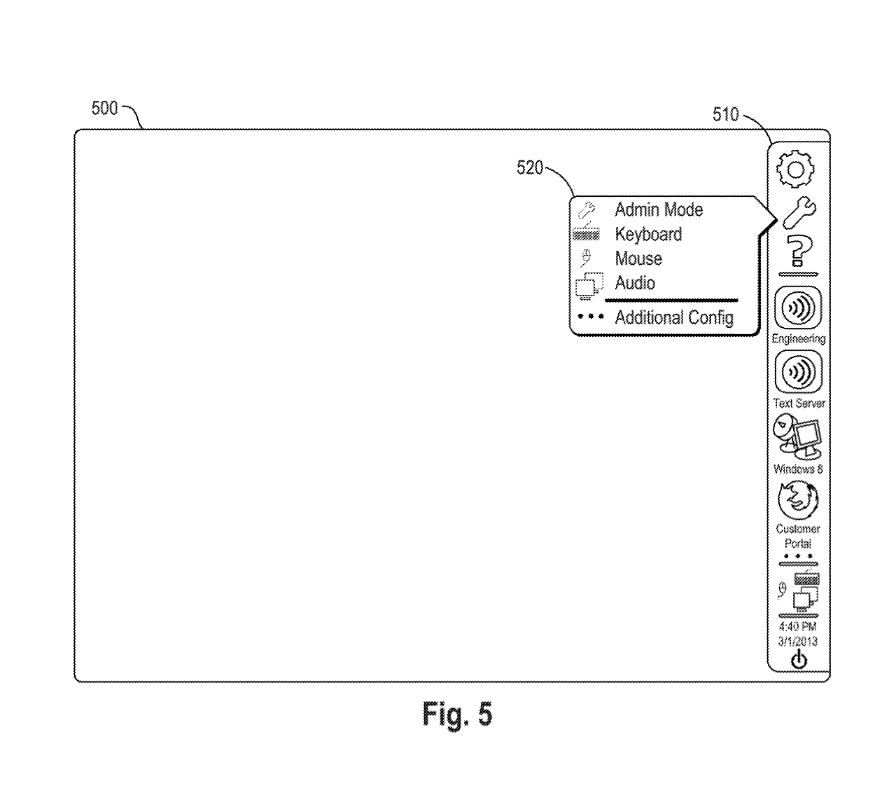

FIG. 5 depicts another example of the user-mode interface 500 in accordance with an implementation. In particular, FIG. 5 depicts the taskbar 510 shown in the user-mode interface 500, where the pop-out window provides the user with the option to enter administrator mode. Further, the pop-out window provides various keyboard, mouse, and audio configurability options. Such configurability options on the user mode interface may have been enabled during a prior setup during administrator mode. In some implementations, a configuration file may be generated based on action taken while in administrator mode that details which widgets are loaded onto the taskbar 510 and in what order. Each widget may have basic registration capabilities, where it registers any settings that may be controlled with the taskbar, such as sub-menus, controls, and sub-widgets. The taskbar then assembles a list of toggles for every widget and associated settings into a single list. The administrator may then select widgets and/or settings within the widget to enable/disable.

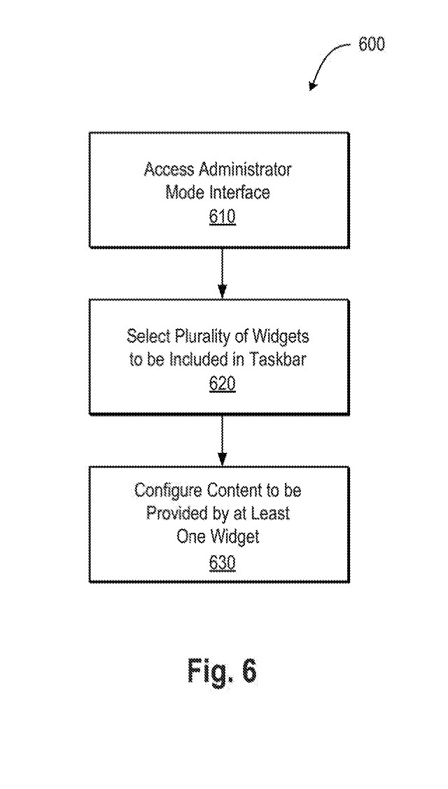

Turning now to FIG. 6, this process flow diagram 600 depicts an example process that may be conducted by the thin client computing device and/or taskbar module of FIG. 1 in accordance with an implementation. It should be readily apparent that the processes depicted in FIG. 6 represent generalized illustrations, and that other processes may be added or existing processes may be removed, modified, or rearranged without departing from the scope and spirit of the present disclosure. In addition, it should be understood that the processes depicted may represent instructions stored on a processor-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components. Furthermore, the flow diagrams are not intended to limit the implementation of the present disclosure, but rather the flow diagrams illustrate functional information that one skilled in the art could use to design/fabricate circuits, generate software, generate logic, or use a combination of hardware and software to perform the illustrated processes.

The process 600 may begin at block 610, where a user/administrator accesses the administrator mode interface. As mentioned, the administrator-mode interface may be accessible by selection of an icon within a single taskbar (see, e.g., element 420 in FIG. 4). As further mentioned, the administrator-mode interface may be the only interface to the thin client computing device settings.

At block 620, the user/administrator selects a plurality of widgets to be included within the taskbar. In some implementations, these selected widgets are displayed within the taskbar in the user-mode interface and in the administrator-mode interface. In addition, in some implementations, at least one of the plurality of widgets is to communicate with an application running on the thin client computing device and provide active content from the application within the single taskbar. For example, the widget may communicate with an application connecting to a remote desktop or remote application such as a Citrix® application, Microsoft® remote desktop application, and VMware® application to receive active content. The active content may comprise, for example, and with respect to a connection to a server, at least one of connection information, graphics information, and performance information.

At block 630, the user/administrator configures content provided by at least one of the widgets. In some implementations, the content provided is configured such that different content is provided by the widget depending on whether or not the thin client computing device is connected in a remote session. For example, the type of content provided when connected in the remote session may comprise at least one of information about the identity of a server, information about applications running on the server, and information about enabled options. By contrast, the type of content provided when not connected in the remote session may comprise at least one of information about an earlier connection, information about the user, and information about available servers to connect to.

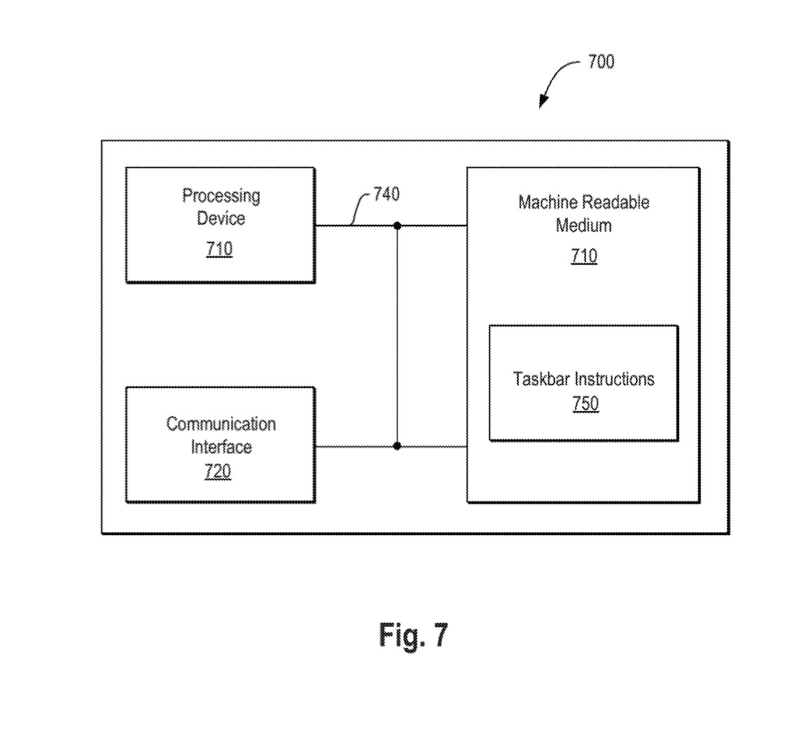

FIG. 7 depicts an example thin client computing device 700 comprising a machine-readable medium in accordance with an implementation. The example thin client computing device 700 comprises a processing device 710, a non-transitory machine readable medium 720, and a communication interface 730. The processing device 710, machine-readable medium 720, and communication interface 730 are communicatively coupled via a bus 740.

The communication interface 730 may comprise, for example, transmitters, receivers, transceivers, antennas, ports, PHYs, and/or other communication components. Moreover, the communication interface 730 may comprise a wireless network interface (e.g., to communicate in accordance with IEEE 802.11a/b/g) and/or a wired network interface (e.g., to communicate in accordance with IEEE 802.3).

The machine-readable medium 720 may correspond to any typical storage device that stores instructions, such as programming code or the like. For example, the non-transitory machine-readable medium 720 may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to hard disk drives, compact disc drives, digital versatile disc drives, optical devices, and flash memory devices. In some implementations, the instructions may be part of an installation package that may be executed by the processing device 710. In this case, the non-transitory machine-readable medium 720 may be a portable medium such as a CD, DVD, or flash drive or a memory maintained by a server from which the installation package can be downloaded and installed. In another implementation, the instructions may be part of an application or application already installed on the thin client computing device 700. Further, in some implementations, the instructions may be stored on a server and provided to the thin client computing device 700 as part of a virtual desktop.

The processing device 720 may be at least one of a processor, central processing unit (CPU), a semiconductor-based microprocessor, or the like. It may retrieve and execute instructions such as the taskbar instructions 750 to cause the thin client computing device 700 to operate in accordance with the foregoing description of the taskbar module. In one example implementation, the processing device 710 may access the machine-readable medium 720 via the bus 740 and execute the taskbar instructions 750 to cause the thin client computing device 700 to provide an administrator-mode interface, wherein the administrator-mode interface is (i) accessible by selection of an icon within a taskbar, (ii) the only interface to the thin client computing device settings, (iii) enables selection of widgets to be displayed in the taskbar during a user-mode interface, (iv) enables configuration of the type of content to be displayed within the selected widgets, and (v) enables configuration of user access privileges. The taskbar instructions 750, when executed, may further cause the thin client computing device 700 to provide the user-mode interface, wherein the user-mode interface comprises the taskbar as configured via the administrator-mode interface, and wherein user access is limited in the user-mode interface based on the user access privileges as configured via the administrator-mode interface.

The foregoing describes a novel and previously unforeseen approach to a taskbar for a thin client computing device. The taskbar includes widgets that have the ability to register active content within the taskbar rather than by launching an external application. That is, the taskbar embeds active content widgets into the taskbar to provide up-to-date system, connection, network, debug, and settings information in a manner that does not require launching separate applications, managing windows, exiting the customer session, or taking over session screen. This ensures the user has a very tight, integrated experience inside the remote session, while ensuring that all system settings, diagnostics, and information are just a few clicks away. Furthermore, the taskbar can be scaled to the specific customer environment, regardless of the security concerns and customer use cases present in that environment.

With specific respect to interaction between the taskbar and the remote session, aspects of the present disclosure enable the GUI of the operating system to be embedded in the taskbar. This enables the user to enjoy a seamless experience when embedded in a remote session. For example, key parameters such as CPU, RAM, GPU, and/or memory usage information may be displayed via graphs within the taskbar. A user, consequently, does not have to launch a separate application and interrupt their remote session to obtain such information. Moreover, benchmark information, active connection information, and/or networking information may be displayed in real-time within the taskbar without having to launch a separate application. Hence, the user has a seamless uninterrupted remote application experience via a taskbar with embedded active content. Moreover, rather than being locked in a pre-programmed interface, an administrator has the ability to configure what is visible in user mode. In particular, the administrator has the ability in the administrator-mode interface to setup which widgets are to be displayed in the taskbar, what information is to be displayed in the respective widgets, and/or what privileges the user has in the user-mode interface. Therefore, the present disclosure provides the administrator with complete control over the user-mode interface, thereby enabling the administrator to tailor the interface to meet requirements particular to the organization's need with respect to interface configuration and/or user accessibility.

While the above disclosure has been shown and described with reference to the foregoing examples, it should be understood that other forms, details, and implementations may be made without departing from the spirit and scope of the disclosure that is defined in the following claims.

What is claimed is:

1. A method comprising:
accessing, via a thin client computing device, an administrator-mode interface, wherein the administrator-mode in is accessible by selection of an icon within a single taskbar, and wherein the administrator-mode interface is the only interface to access the thin client computing device settings;
selecting, via the administrator-mode interface, a plurality of widgets to be displayed within the single taskbar during a user-mode interface, wherein at least one of the plurality of widgets is to communicate with an application running on the thin client computing device and provide active content from the application within the single taskbar; and
configuring, via the administrator-mode interface, the type of content provided by at least one of the plurality of widgets, wherein the type of content provided by the at least one of the plurality of widgets differs when connected in a remote session and when not connected in the remote session.

2. The method of claim 1, wherein the active content comprises, with respect to a connection to a server, at least one of connection information, graphics information, and performance information.

3. The method of claim 1, wherein the application running on the thin client device comprises an application connecting to a remote desktop or remote application.

4. The method of claim 1,
wherein the type of content provided when connected in the remote session comprises at least one of information about the identity of a server, information about applications running on the server, and information about enabled options; and
wherein the type of content provided when not connected in the remote session comprises at least one of information about an earlier connection, information about the user, and information about available servers to connect to.

5. The method of claim 1, further comprising:
configuring, via the administrator mode interface, user access privileges with respect to at least one of configuring connection settings, configuring display settings, configuring audio settings, powering off the thin client computing device, and rebooting the thin client computing device.

6. A thin client computing device, comprising:
a communication interface to communicate with a remote server to establish a remote session and
a taskbar module, wherein the taskbar module is to
provide an administrator-mode interface, wherein the administrator-mode interface is (i) accessible by selection of an icon within a taskbar, (ii) the only interface to the thin client computing device settings, (iii) enables selection of widgets to be displayed in the taskbar during a user-mode interface and configuration of the type of content to be displayed within at least one of the selected widgets, and (iv) enables configuration of user access privileges with respect to at least one of configuring connection settings, configuring display settings, configuring audio settings, powering off the thin client computing device, and rebooting the thin client computing device; and
provide the user-mode interface, wherein the user-mode interface comprises the taskbar as configured via the administrator-mode interface, and wherein user access is limited in the user-mode interface based on the user access privileges as configured via the administrator-mode interface.

7. The thin client computing device of claim 6, wherein configuration of the type of content to be displayed within at least one of the selected widgets comprises configuring the type of content displayed when connected in the remote session, and configuring the type of content displayed when not connected in the remote session.

8. The thin client computing device of claim 7,
wherein the type of content displayed when connected in the remote session comprises at least one of information about the identity of a server, information about applications running on the server, and information about enabled options; and
wherein the type of content displayed when not connected in the remote session comprises at least one of information about an earlier connection, information about the user, and information about available servers to connect to.

9. The thin client computing device of claim 6, wherein at least one of the selected widgets is to communicate with an application running on the thin client computing device and provide active content from the application within the taskbar.

10. The thin client computing device of claim 8, wherein the application running on the thin client device comprises an application connecting to a remote desktop or remote application.

11. A non-transitory machine-readable medium comprising instructions which, when executed, cause a thin client computing device to:
provide an administrator-mode interface, wherein the administrator-mode interface is (i) accessible by selection of an icon within a taskbar, (ii) the only interface to the thin client computing device settings, (iii) enables selection of widgets to be displayed in the taskbar during a user-mode interface, (iv) enables configuration of the type of content to be displayed within at least one of the selected widgets, and (v) enables configuration of user access privileges; and
provide the user-mode interface, wherein the user-mode interface comprises the taskbar as configured via the administrator-mode interface, and wherein user access is limited in the user-mode interface based on the user access privileges as configured via the administrator-mode interface,
wherein user access privileges comprises at least one of connection settings privileges, display settings privileges, audio settings privileges, powering off the thin client computing device privileges and rebooting the thin client computing device privileges, and
wherein at least one of the selected widgets is to communicate with an application running on the thin client computing device and provide active content from the application within the taskbar.

12. The non-transitory machine-readable medium of claim 11, wherein configuration of the type of content to be displayed within at least one of the selected widgets comprises configuring the type of content displayed when connected in a remote session, and configuring the type of content when not connected in the remote session.

13. The non-transitory machine-readable medium of claim 12,
wherein the type of content displayed when connected in the remote session comprises at least one of information about the identity of a server, information about applications running on the server, and information about enabled options; and
wherein the type of content displayed within the at least one selected widget when not connected in the remote session comprises at least one of information about an earlier connection, information about the user, and information about available servers to connect to.

14. The non-transitory machine-readable medium of claim 11, wherein the active content comprises, with respect to a connection to a server, at least one of connection information, graphics information, and performance information

15. The non-transitory machine-readable medium of claim 11, wherein the administrator-mode interface further enables configuration of placement of the selected widgets within the taskbar.
